(19) United States
(12) Patent Application Publication
(10) Pub. No.: US 2010/0221972 A1
(43) Pub. Date: Sep. 2, 2010

(54) Composite Fiber-Based Compositions and Methods

(75) Inventor: David S. Soane, Chestnut Hill, MA (US)

Correspondence Address: NUTTER MCCLENNEN & FISH LLP, SEAPORT WEST, 155 SEAPORT BOULEVARD, BOSTON, MA, 02210-2604, US

(73) Assignee: Soane Labs, LLC, Cambridge, MA (US)

(21) Appl. No.: 12/690,959

(22) Filed: Jan. 21, 2010

Related U.S. Application Data
(63) Continuation of application No. PCT/US2008/073294, filed on Aug. 15, 2008.
(60) Provisional application No. 60/964,826, filed on Aug. 15, 2007.

(51) Int. Cl. D04H 13/00; B05D 1/12; B05D 5/12; B05D 1/30; B05D 1/18

(52) U.S. Cl. 442/327; 427/180; 427/58

(57) ABSTRACT

Methods and materials are reveled relating to novel fibrous materials such as textiles. In some instances, methods are revealed for using various types of precursors for forming designated fiber patterns for textile sheets and structures. Such methods can provide tailored textiles with properties and features that are not achievable using typical woven fabrics and manufacturing techniques. Precursors can be utilized in conjunction with preformed fibers or existing textile materials to provide modified textiles as well.

### CROSS REFERENCE TO RELATED APPLICATIONS

The present application is a continuation of PCT International Application No. PCT/US2008/073294, filed Aug. 15, 2008, entitled “Composite Fiber-Based Compositions and Methods,” which claims the benefit of U.S. Provisional Patent Application, bearing Ser. No. 60/964,826, filed Aug. 15, 2007, entitled “Composite Fabric-Based Compositions and Methods.” The entire contents of both above-listed applications are incorporated herein by reference in their entirety.

### FIELD OF THE APPLICATION

The technical field of this application is directed toward compositions and methods related to materials, and in particular to items such as fibrous materials (e.g., textiles and/or other materials in which the fibers are patterned), which can optionally be manufactured from polymer-based materials.

### BACKGROUND

Textiles and fabrics that are utilized in apparel manufacturing traditionally have properties, which can differ from other film or sheet materials. Examination of the construction of a woven sheet of fabric reveals crossed fibers having dimensions typically in the 10-50 micrometer range. Between the crossed network of fibers are void spaces (mesh openings) that allow the fabric to breathe and transport perspiration. This construction is also responsible for the flexible drape and pleasant tactile properties of the fabric.

Traditional approaches to fabric and apparel manufacturing have always relied on conversion from weaving or knitting into sheets, followed by cutting and/or sewing into tailored garments and other finished textile objects. Even with the advent of computer control and equipment automation, these production methods are ultimately limited in their maximum level of output. Weaving, for example, is accomplished by very fast shuttling of a fill yarn across many parallel warp yarns in a synchronized movement that yields the desired textile pattern. The fill yarn must travel the width of the fabric before the fabric is lengthened by only approximately the diameter of the fill yarn itself. This large disparity of dimensions is the root cause of the limited linear speed of fabric production.

Furthermore, the properties of textiles and fabrics as commercially manufactured today are often limited. Conventional fabrics for everyday use and sports wear can be made of either natural or synthetic fibers. Cotton, wool and silk are generally more comfortable, but less durable. All shrink and wrinkle readily. Polyester and nylon are mechanically more robust, but moisture management and tactile feel are inherent issues with these synthetic fabrics.

Two traditional approaches have been extensively employed to offer products that represent a compromise of properties: mixed weave (as in a blended textile) and lamination. For example, polyester-cotton or nylon-cotton blends are modestly more durable and wrinkle resistant than cotton, but are not as comfortable to wear, and are less abrasion and tear resistant than their full synthetic counterparts. The other alternative, lamination, is labor intensive, often involves the use of a binder, and artificially forces two or more sheets to join by stitching or gluing. The forced mating of divergent materials creates a host of problems associated with differential shrinkage and heat distortion, thus post-laundry warpage, necessitating complicated care instructions. Teflon (e.g., Gore-Tex®) outer shell combined with a liner is a salient example of lamination to give a high performance water and oil repellent fabric.

Accordingly, a need exists for improved methods and compositions for forming textiles and fabrics. As well, a need also exists for forming new textiles and fabrics that have improved properties relative to existing materials, and/or that are easier to manufacture relative to conventional methods.

### SUMMARY

In this disclosure, we advance a novel approach for fabric manufacture, resulting in greatly enhanced productivity and textile variety. The fundamental approach is amendable to many process variations and can accommodate numerous material systems. In some aspects, the present application discloses unique and novel manufacturing process/material combinations that transform a fiber/yarn-based approach to one that can create the sheet fabric directly.

As mentioned previously, traditional fabric manufacture relies on the making of fibers first, before their mechanical assembly into the final pattern. In some aspects of the present invention, we create the fibrous patterns in-situ, while a whole sheet of fabric is produced. In other aspects, formulations are applied to the surface of a textile to change the tactile or other surface properties of the textile relative to its native surface.

Some embodiments are directed to methods for changing the tactile properties of a textile. The textile can be a woven material, a non-woven material, or a combination of the two. As well, the textile can include synthetic fibers and/or exhibit elastic properties. A fiber-containing composition can be provided, which can include microfibers (e.g., cellulosic microfibers) and a dispersing fluid. The dispersing fluid can include one or more of water and a non-aqueous solvent. The fiber-containing composition can be distributed onto at least a portion of the textile to form at least a portion of a tactile-changing composition. The tactile-changing composition can impart a change in the tactile properties of the textile relative to a native textile surface. For example, the tactile-changing composition can impart a cotton-like tactile quality to the textile. In some instances, at least part of the tactile-changing composition can be non-covalently attached to the textile. In some instances, the fiber-containing composition can include a precursor composition for forming a binder. Thus, the tactile-changing composition can include the binder acting to adhere the microfibers. Such methods can be applied to create textiles, which can be used to construct garments or other textile-containing structures.

In some instances, a fiber-containing composition can include one or more other components. For example, the fiber-containing composition can include a crosslinking agent capable of crosslinking at least a portion of the microfibers, and/or a dispersing agent to aid dispersal of the microfibers.

In some instances, a tactile-changing composition can include polycations (e.g., amine-containing polymers) that can be attached to the microfibers. At least some of the polycations can also be optionally attached to the textile. The polycations can be contacted with the distributed fiber-containing composition (e.g., after distribution on the textile), which can result in attachment to the microfibers. Alternatively, the microfibers can be attached to the polycations before the fiber-containing composition is distributed. Polycations can also be crosslinked, which can increase the resiliency of the tactile-changing composition. Crosslinking can be performed using a crosslinking agent that can include one or more of an epoxide, an isocyanate, and an aldehyde.

In other instances, the textile can be formed having fibers with functionalized groups. For example, the fibers of the textile can be formed from a precursor solution, the formed fibers having the functionalized groups. The microfibers can then be attached to at least a portion of the textile using at least some of the functionalized groups. In some cases, the fibers of the textile can be covalently attached to a coupling agent that bears at least one of the functionalized groups. In other cases, the tactile-changing composition includes polycations (e.g., amine-containing polymers) attached to the microfibers. Attachment of the microfibers to the textile can include attaching at least one polycation to at least one functionalized group.

Other embodiments are directed to a modified textile for changing the tactile properties of a native textile surface. Such modified textiles can be used to manufacture any type of suitable structure such as a garment. A tactile-changing composition can be disposed on at least part of a native textile surface. The textile can be a woven material, a non-woven material, or a combination of the two. As well, the textile can include synthetic fibers and/or exhibit elastic properties. The tactile-changing composition can include microfibers (e.g., naturally-occurring microfibers such as cellulosic microfibers) capable of imparting a change in tactile properties of at least part of the native textile surface (e.g., the part having the composition applied thereto). In some instances, microfibers can exhibit an average diameter between about 10 micrometers and about 100 micrometers, and/or exhibit an average length between about 100 micrometers and about 10 millimeters. In particular instances, at least some of the microfibers can include a plurality of fibrils, which can potentially be separated. The fibrils can have a nanofiber structure, e.g., exhibiting an average diameter between about 1 nm and 1 micrometer, or between about 50 nm and about 500 nm.

The tactile-changing composition can be disposed as multiple discrete sections distributed on the native textile surface, or as a continuous coating. In some instances, at least part of the tactile-changing composition can have a thickness between about 1 millimeter and 1 micrometer, which can aid in imparting desirable tactile properties. In some cases, the tactile-changing composition can include a binder composition, which can hold the microfibers together. A binder composition can include a resin or other material, which can optionally include any combination of an acrylic, an epoxy, a polyurethane, and a melamine.

In some instances, the tactile-changing composition can include a crosslinker, which can be used to crosslink at least some of the microfibers (e.g., by covalently attaching at least two microfibers together). Alternatively or in addition, the tactile-changing composition can include polycations (e.g., amine-containing polymers) attached to at least a portion of the fibers. Such polycations can be crosslinked together, and/or attached to the textile.

In other instances, the native textile surface can include functional groups, which can be used to attach at least some microfibers to the native textile surface. For example, coupling agents can be included, which can act to connect one or more functional groups to a native textile surface.

Some embodiments are directed to a synthetic textile, which can have pore sizes dependent upon the temperature to which the textile is exposed. The synthetic textile can include a structural layer having a first polymeric material, and configured to include a plurality of openings. The synthetic textile can also include a variable covering layer constructed using a second polymeric material, where the second polymeric material can have a higher thermal expansion coefficient than the first polymeric material. In some instances, the first polymeric layer can be made from a material having a higher T_{g} than the second polymeric material. The variable layer can be disposed adjacent to the openings of the structural layer, and can be configured to cover the openings when the temperature is below a lower selected temperature. The variable layer can also be configured to expose at least a portion of the openings when the temperature is above a higher selected temperature.

Some embodiments are directed to methods of textile formation, which can utilize a precursor to form fibers. Such textiles can exhibit draping characteristics. The precursor can be applied onto a substrate to form the shape of the textile. Precursor application can utilize any number of techniques, which can potentially include any combination of an air-knife technique, immersion, gap coating, curtain coating, rotary screen, reverse rolling, gravure coating, metering rod coating, a slot die technique, a hot melt technique, a flexo technique, silk screening, and anilox coating. As well, the substrate can be configured to arrange the precursor to form the shape. For instance, the substrate can have a surface that includes at least one of ridges and grooves for forming the textile shape. In another instance, the substrate can have a surface that includes at least two different materials configured to form the textile shape. As well, a temperature gradient and/or a charge distribution can be arranged on the substrate surface to form the textile shape and/or arrange the precursor.

The textile shape can include elongated structures in a defined pattern for forming fibers and void spaces. For example, at least one fiber can be formed as a closed loop; a plurality of fibers can be configured as nested closed loops. The void spaces and/or the fibers of the textile can have a characteristic dimension of at least about 1 micrometer. The precursor can then be cured to form the textile. Curing can include subjecting the elongated structures to any combination of light, a change in temperature, and air. In some instances, the elongated structures can be cured to a partially cured state. The partially cured textile can be contacted to one or more other partially cured textiles. The ensemble can then be cured to affix the textiles together.

The textile can be removed from the substrate. In some instances, a plurality of preformed fibers can be provided on the substrate. The elongated structures can then be contacted with the preformed fibers to form the textile shape. In one instance, the elongated structures adhere to the substrate. Subsequent textile removal can also include rupturing the elongated structures (e.g., fibers) to form whiskers extending from the elongated structures; this can impart a fleece-like quality to the textile. In another instance, the elongated structures can form a textile with at least one raised region. In yet another instance, a plurality of layers can be formed into a textile with each layer including at least one elongated structure.

In some instances, other agents can also be embedded in the textile. Such agents can include at least one of an anti-microbial agent, a fragrance, a pest repellant, and a pigment with the textile. In some cases, a conductive metal can be deposited onto the textile.

In other instances, the precursor can include a semi-solid precursor. In such instances, among others, one or more openings can be formed (e.g., by at least one of cutting and punching) in the textile shape before the precursor is completely cured. For example, opening(s) can be formed by covering a portion of the textile shape with a mask. The uncovered portion of the textile can be exposed to light, which can change the nature of the light-exposed portion. Subsequently, either the covered portion or the uncovered portion can be dissolved to form openings in the textile shape. In some cases, the textile shape can be stretched to enlarge the size of at least one of the openings.

In some instances, the substrate can include the surface of a roller. For example, the substrate can include a plurality of rollers each having parallel lines imprinted thereon. The plurality of rollers can be configured to arrange the precursor to form the elongated structures (e.g., crossed elongated structures and/or broken and/or staggered structures).

In other instances, the substrate can include the surface of a mold (e.g., a three-dimensional mold). The mold can be configured to form a textile shape with edges capable of interlocking with edges of other textiles and/or having a roughness for promoting adhesive fixation. The mold can include at least two complementary portions. The precursor can be applied to at least one of the complementary portions; optionally, a second precursor can be applied to an opposite complementary portion. The complementary portions can be contacted with the applied precursor to form a three-dimensional textile shape, which can be seamless. The three-dimensional textile shape can be any of a tube-like structure, a sleeve of a garment, a pant leg, a glove, or a sock. In some cases, the mold can be configured to form a textile fitted for a particular individual subject.

In some instances, the precursor can include a multiphase mixture. For example, the multiphase mixture can include an aqueous-organic-aqueous emulsion. In such an instance, curing of the precursor can include removing solvent from the emulsion to form porous fibers, or to form fibers having a core-shell structure. In another example, the multiphase mixture can include an organic-aqueous mixture. Such a mixture can include a fiber-forming material in the organic phase, the aqueous phase, or throughout the mixture. In a particular instance, the aqueous phase of the organic-aqueous mixture can include polyacrylic acid and carboxymethylcellulose. In another particular instance, the organic phase of the mixture can include a polyester and an acrylated formulation. Upon evaporating fluid from the one of the phases (e.g., the aqueous phase), a material can be formed over fibers of the textile; the material can be also be crosslinked. In some cases, the multiphase mixture can self-assemble on the surface of a roller such that a curable phase forms a textile shape.

In particular instances, the precursor can be applied to a substrate forming at least one elongated structure on the substrate by depositing the precursor using an ink jet technique. For example, a plurality of elongated structures can be formed using a plurality of nozzles. One or more of the nozzles can be configured to move relative to another nozzle to produce crossing elongated structures, and/or configured to form a continuous elongated structure, a discontinuous elongated structure, or both.

In some instances, a second precursor, which can be different from another precursor used in these methods, can also be applied to the substrate. The second precursor can be cured to form the textile. In some cases, the second precursor can have a different thermal expansion coefficient than the other precursor. Accordingly, these methods can result in a textile that exposes openings from expansion of the second cured precursor relative to the other when the temperature is above a selected temperature.

In some instances, the substrate can include a carrier layer. The carrier layer can include one or more openings formed through the layer. In such an instance, one or more precursors can be applied onto opposite sides of the carrier layer. Such precursors can be of the same type or different types. At least one precursor can be applied to fill at least one opening of the carrier layer. The carrier layer can subsequently be dissolved to form the textile.

In some instances, the precursor can include one or more of a polymer, an oligomer, a monomer, a crosslinker, a macromer, and a reactive diluent. Non-limiting examples include an entity having any combination of an acrylate, a styrenic, an epoxy, and a vinyl ether. In some cases, the precursor includes a block copolymer, which can optionally include polymer segments of at least one of polyethylene terephthalate, silicone, polyamine, and polyacrylic acid.

Some embodiments are directed to methods for textile formation from a liquid, fiber-forming precursor. One or more precursors can be applied onto opposite sides of a film layer to form a shape of the textile; the precursor applied to one side of the film can be of a different type than the precursor applied to the opposite side. Film layers can optionally include one or more agents such as an anti-microbial agent, a fragrance, a pest repellant, and a pigment. A film layer can also include a conductive metal applied thereto. The film layer can include pores for allowing one or more precursors on the opposite sides of the film layer to be in contact with one another. The textile shape can include elongated structures in a defined pattern. The precursor(s) can be cured to form the textile.

Other embodiments are drawn to methods for altering surface properties of a textile. A pattern of precursor can be applied to a surface of a textile. For instance, the pattern can be applied using one or more rollers, which can transfer the pattern of the precursor from the one or more rollers to the surface of the textile. In another instance, the pattern of the precursor can be applied to the textile surface using an ink-jet technique. Other instances can utilize one or more of an air-knife technique, immersion, gap coating, curtain coating, rotary screen, reverse rolling, gravure coating, metering rod coating, a slot die technique, a hot melt technique, a flexo technique, silk screening, and anilox coating to apply the precursor pattern. The textile can be cured to form a cured pattern (e.g., the cured pattern can be a polymerized network), which can bind to the textile surface. The cured pattern can alter the surface properties of the textile. The types of precursors and the types of curing techniques can include any of those disclosed herein. In some instances, the precursor can include a polysaccharide-dominated formulation such as a polyamine (e.g., chitosan). The precursor can also include a graft copolymer such as one including a silicone functionality, which can impart water repellency to the textile. The graft copolymer can also include an oleophobic portion to impart oil repellency to the textile. Other precursors can include one or more of a RTV silicone doped with cyanoacrylate, an epoxy formulation (e.g., a formulation that includes an elastomeric component, a siliconized component, or both), and a compound having at least one triazine functional group.

In one particular instance, a first pattern of the precursor can be applied to the surface of the textile. A second pattern of another precursor can be applied to an opposite surface of the textile. Each pattern can be cured to form cured patterns on the textile surfaces, where each cured pattern can provide a distinct alteration in the surface properties of the textile. For example, the first pattern can be configured to provide a cotton-like surface to the textile, and/or the second pattern can be configured to provide a stain-resistant-like surface to the textile.

Other embodiments are directed to textiles, and/or garments or other textile-containing structures, produced in accord with any of the methods disclosed herein.

### BRIEF DESCRIPTION OF THE DRAWINGS

Aspects of the present invention will be more fully understood from the following detailed description taken in conjunction with the accompanying drawings (not necessarily drawn to scale), in which:

FIGS. 1A-1C present schematic diagrams of patterns of precursor to form textiles in accord with some embodiments of the invention;

FIG. 2 presents a schematic diagram of a roller configured with a hexagonal pattern for producing a textile in accord with some embodiments of the invention;

FIG. 3 presents a schematic diagram of a superabsorbing material in accord with some embodiments of the invention;

FIG. 4A presents a schematic diagram of a temperature sensitive textile in accord with some embodiments of the invention; and

FIG. 4B presents a close up view of the textile shown in FIG. 4A.

### DETAILED DESCRIPTION OF EMBODIMENTS

Embodiments of the present invention are directed to the materials formed from fibers and their manufacture. In some embodiments, methods and compositions of textiles are described. In some aspects, the textiles are produced using one or more precursors or other formulations that can be disposed and/or cured on a substrate. The textile can be subsequently removed from the substrate, or the substrate can even form part of the finished textile. In other aspects, one or more precursors or other formulations can be applied to a pre-formed textile to alter its surface properties.

In some embodiments, by employing various technologies outside the traditional scope of textile manufacturing, fibrous structures with dimensions finer than those produced by fiber spinning (e.g., finer than the order of micrometers) can be created with some of the embodiments described herein. Some embodiments provide direct fiber production of the textile in-situ, providing the potential advantage of rapid throughput. Since textile patterns can be deliberately and directly generated, these embodiments depart significantly from spun-bonding and paper-making, where pre-existing fibers are randomly stacked.

### Textile Fabrication

Some embodiments are directed to textiles that can be formed from precursors. The terms “textile” and “fabric” can be used interchangeably herein, and refer to a material comprising a network of fibers. The network can comprise a woven material or a non-woven material. In some instances, the fibers (e.g., which are non-woven) can be held together by any number of means including chemical bonding. Though some embodiments of textiles are formed using techniques utilized in forming embossed sheets (e.g., a polymer melt is squeezed through a narrow gap, known as the nip region, of a set of calender rolls with embedded surface features), typical embossed sheets are solid, and do not mimic textiles that breathe and drape. In this regard, a textile is more like a layer of fibers, where interconnected voids permeate throughout the structure. However, the textile differs from structures where fibers are randomly stacked with relatively little member-to-member adhesion, resulting in a structure that lacks mechanical strength and overall film flexibility. Accordingly, textiles have qualities that are characteristics of fabrics, such as drape. Drape, the characteristic by which a fabric is deformed by gravity when a portion is not supported, is induced when the fibers or yarns are organized in defined patterns.

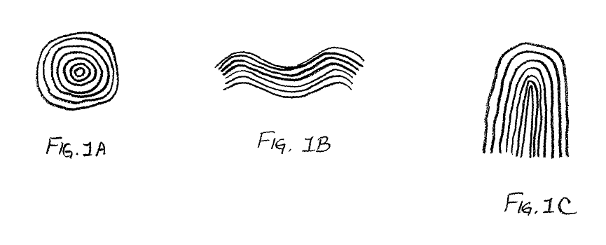

Accordingly, some embodiments are directed to textiles in which the fibers are organized in some type of defined pattern (e.g., not random). Since most conventional textiles are composed of woven fibers, the textile fibers are often laid out in a grid-like pattern. But embodiments of the present invention can utilize novel techniques of textile formation, which do not necessitate a woven fiber structure (e.g., the fibers are held in relative position by some other mechanism such as chemical bonding). Accordingly, aspects of the present application depart from both straightforward embossing and papermaking, in that open structures with fabric-like strength and flexibility are made directly from processes/materials capable of in-situ fibrous pattern generation. Thus, the fibers can be defined in many patterns that are not amenable to woven techniques such as such as herringbone, continuous circles, highly branched and dendritic structures, articulated patterns, and waves, etc. Some examples of these patterns are shown in FIGS. 1A-1C. Furthermore, unlike most conventional textiles that utilize fibers that span the width of the textile, some embodiments herein can utilize discontinuous fibers (e.g., fibers organized in a grid like fashion but missing one or more portions). Thus, the defined pattern of a textile can be practically any identifiable pattern.

Textiles are typically formed by fibers having thicknesses in about the 10 to 50 micrometer range, with void spaces formed with characteristic dimensions in a similar range. The characteristic dimension is a spatial dimension that is characteristic of the spatial extent of the object (e.g., fiber thickness or void space). Examples include an average value of diameter, radius, diagonal of a square, square root of an area, cube root of a volume, largest spatial extent, etc. Average values can be calculated using any number of techniques, including those known to one skilled in the art. Accordingly, embodiments of the present invention can result in textiles having a fiber thickness and/or a void space having a characteristic dimension of at least about 1, 5, or 10 micrometers. As well, the characteristic dimension can also be less than about 200, 100, or 50 micrometers. It is understood, however, that the techniques discussed herein can also be used to form textiles and other fibrous materials having dimensions outside the ranges discussed explicitly herein.

The term “fiber,” as used within the present application, typically refers to an elongated structure that is used to form a portion of the textile, i.e., the length of the structure is longer than the width of the structure. For instance, the elongated structure can have a cross sectional area such that its square root is no larger than about ½, ⅓, ¼, ⅕, or about 1/10 the length of the structure. The fiber can be formed from precursor that is formed in an elongated structure and cured. Thus, in some instances, an elongated structure formed from one or more precursors can be cured to form a fiber. Fibers can be formed from natural and/or synthetic materials, and can be pre-formed or formed by one or more of the methods described herein. Examples of s that can be used to form fibers are disclosed herein. The fiber cross-sections can be of any shape (e.g., circular or varying along the length of the fiber).

The phrase “precursor” as utilized herein refers to a deformable material that can be transformed into a fiber for use in textiles, as described in some embodiments. In many embodiments, the precursor is a liquid formulation. However, a precursor need not be a true liquid in a thermodynamic sense, and can include materials such as gels, viscoelastic fluids, and other deformable materials. Such precursors can typically be shaped into a textile, and in many instances into elongated structures that can become fibers upon curing. Examples of precursors include polymer formulations that contain polymers or components that can become polymers after reaction. In many embodiments, a precursor is chosen such that the precursor can be cured to form a fiber. Curing of the precursor can be achieved by any number of techniques including air drying, self-reaction of the precursor, exposing the precursor to light of one or more wavelengths (e.g., ultraviolet or infrared light), exposing the precursor to a given temperature or range of temperatures. The specific mechanisms of curing are discussed herein with respect to the type of liquid precursor(s) utilized. In some instances, a cured precursor can undergo a chemical reaction, though this is not necessarily the case (e.g., drying of a precursor to remove solvent).

The term “polymer” can refer to a molecule comprising a plurality of repeat units or monomers. A polymer can comprise one or more distinct repeat units. For example, a “copolymer” refers to a polymer having two or more distinct repeat units. Repeat units can be arranged in a variety of manners. For example, a homopolymer refers to a polymer with one type of repeat unit where the repeat units are adjacently connected. In another example, a plurality of different repeat units can be assembled as a copolymer. If A represents one repeat unit and B represents another repeat unit, copolymers can be represented as blocks of joined units (e.g., A-A-A-A-A-A . . . B-B-B-B-B-B . . . ) or interstitially spaced units (e.g., A-B-A-B-A-B . . . or A-A-B-A-A-B-A-A-B . . . ), or randomly arranged units. Of course, these representations can be made with 3 or more types of repeat units as well. In general, polymers (e.g., homopolymers or copolymers) include macromolecules in a broad range of configurations (e.g., cross-linked, linear, and/or branched). The polymer can be disposed in a variety of mixture dispositions such as solutions, melts, and/or gels. A gel refers to a state where a mixture of polymer and liquid has at least some properties that make the mixture behave more like a solid than a viscous liquid (e.g., the mixture exhibits elasticity). Various embodiments described herein are directed to compositions, or use thereof, that include a polymer having one or more of the specific properties discussed above. Oligomers are generally encompassed within the definition polymers, though oligomers typically include from about 2 to about 20 repeat units, whereas polymers can utilize any number of repeat units.

Some embodiments of the present invention are directed to methods of forming a textile, or other fibrous materials, using a precursor to form the fibers thereof. The precursor can be applied to a substrate to form a shape for the textile. The precursor is also capable of being cured to form the textile. In some instances, cured precursor forms the textile, and the textile is removed from the substrate. In other instances, the substrate actually forms part of the finished textile. Various aspects of these embodiments are discussed more thoroughly herein.

The textile shape formed by a precursor refers to a geometric conformation of the precursor, which upon curing forms a textile. For example, in many embodiments the textile shape can be substantially similar to the completed textile, though some amount of expansion or contraction can occur. In some instances, substantial rearrangement of the precursor can occur that can result in a textile structure that differs from the shape formed by the precursor. As well, the completed textile can have any number of characteristics as discussed within the present application (e.g., draping characteristics, void or pore sizes, fiber sizes, etc.).

In some embodiments, the phrase “direct casting and imprinting” is used to describe some aspects of applying a precursor to a substrate. In some instances, the fibers are formed from one or more precursors while the desired fabric pattern is generated. Hence, the fiber layout can be organized in a defined pattern, giving the sheet a desired strength and flexibility. For example, a textile sheet thus produced can contain numerous void spaces (e.g., mesh openings) that resemble a traditional fabric in its transport properties.

### Textile Formation on a Substrate

Substrates used to form a textile, in some embodiments of the present invention, can include the types of substrates used to print on paper-materials, and/or form films in coating applications. Some examples of the types of techniques that apply formulations to a substrate, which can be applied in embodiments described herein, include an air-knife technique, immersion, gap coating, curtain coating, rotary screen, reverse rolling, gravure coating, metering rod coating, a slot die technique, a hot melt technique, a flexo technique, silk screening, and anilox coating. Though some embodiments herein will refer to the application of precursors to particular substrates, it should be understood that any other substrate, including those used in the techniques listed above, can be used within the scope of the present application.

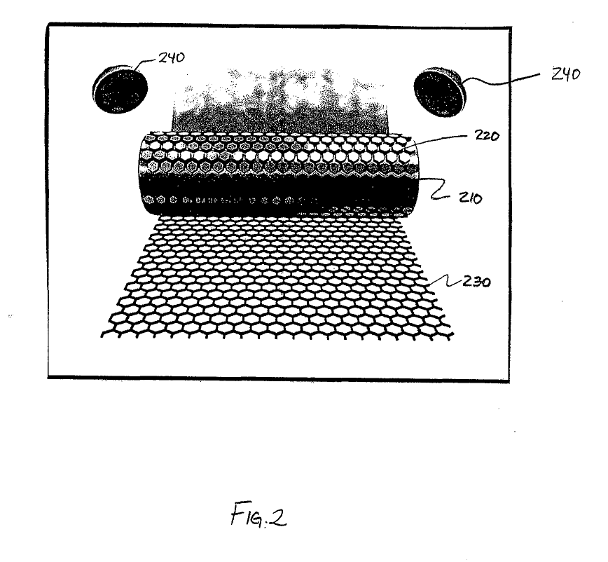

In some embodiments, a substrate can be configured to arrange a precursor to form a desired textile shape (e.g., having a defined pattern such as fiber orientation or void formation patterns). In several embodiments discussed herein, the substrate that is configured comprises one or more rollers. Such embodiments can be advantageous since continuous, or semi-continuous, textile formation can be achieved. For example, as shown in FIG. 2, a roller 210 is configured with a hexagonal pattern 120. A precursor can be applied to the roller 210 such that the precursor is formed into the hexagonal pattern 230. A light source 240 can be used to impinge radiation (e.g., ultraviolet light) onto the precursor pattern 230, which can act to cure the precursor into a solid-like patterned material. It is understood, however, that flat or curved substrates used in batch processes, or other continuous processes, can also be configured to arrange the precursor to form a textile shape.

One example of a substrate configured to arrange a precursor in a textile shape is to form ridges, grooves, and/or other structures on a surface such as a surface of a roller. For example, the substrate surface can include parallel lines imprinted as grooves or ridges. In some embodiments, a substrate is configured to have an affinity for a selected precursor (e.g., a hydrophobic precursor being drawn into the organophilic coated gaps of a surface to form a fiber network such as a grid). Accordingly, the precursor can maintain a particular pattern until it is cured to form a fiber. In some instances, particular pattern portions of the substrate having differing chemical characteristics for forming the precursor into a desired pattern (e.g., organophilic on one portion and hydrophilic on another portion).

In various embodiments, forming the surface of a substrate to mimic a textile shape can take advantage of various micropattern techniques used in various technologies such as forming patterns on substrates such as rollers and other solid substrates for holding a precursor. For instance, generation of 10-50 micrometer patterns, and smaller, is well within the reach of photolithography techniques practiced today in the electronics industry. The pattern can be directly imaged on a sheet of material capable of photo-initiated reactions. Alternatively, metal, polymer, or ceramic surfaces with patterns having dimensions in the range of multiple micrometers are commonly made today. Patterning on rollers and other substrates can utilize technologies such as color printing and embossed sheet formation. For example, color printing technologies that utilize high resolution can be applied to textile manufacture, and can be applied with precise pattern registration between layers. Embossed sheet formation further validates the durability of the patterned roller surfaces in processing molten viscous fluids or softened solids.

It is understood that more than one roller can be used to arrange the liquid substrate into a textile shape. For example, a set of matched rollers can be used, with precursor applied to a gap between the rollers that can fill one or more intersticies of one roller, while a matching raised portion of the other roller also fills the gap and confines the precursor in the gap. As well, two rollers can be placed adjacent to one another in which the surface of each roller has a pattern that is dissimilar to the surface pattern of the other roller. For example, two mating rollers can have parallel grooves. One set of grooves of one roller runs across the width of the roller, whereas the other spans the circumference along the surface. When the precursor is squeezed through a nip region, a criss-crossed fibrous pattern is produced. Note that these lines or grooves do not have to be continuous through the length and width of the fabric. Broken or staggered patterns produce sheets with increased flexibility.

Ridges and grooves of a substrate (e.g., roller) surface can be switched or substituted with a myriad of other candidate materials of construction. Further, the surface of the substrate does not even have to possess a three-dimensional topography. Flat, or essentially flat, “in-laids” made of dissimilar materials can imprint the desired intrinsic patterns on the precursor.

Even in the case where the ridges and grooves are made of the same material, if a substantial temperature differential (e.g., a temperature gradient) exists between different portions of the substrate surface (e.g., the high and low points) spontaneous pattern assembly may occur within the precursor. In this case, the precursor may or may not be a multiphase system. For example, polymers can precipitate or crystallize around cold points from a meta-stable solution, leaving a solvent-rich solution around hot spots.

In another embodiment, a substrate surface is configured as a semi-conductive surface that is capable of temporarily holding a selected charge distribution that can be spatially distributed. For example, when a roller is defined to have a suitable conductive surface, precursors are applied to the surface, like “toner” droplets that are attracted to charged spots on the rollers. The application of ink-jet technology, as described further herein, can be especially useful with this embodiment. When heat-fused, a pattern emerges. The precursors can be polymerized/crosslinked by curing into porous sheet-like with programmed textile patterns.

As previously mentioned, since the techniques described herein do not rely on weaving, many patterns of fibers can be created into textiles without the typical constraints imposed by conventional fabric formation. For example, one or more fibers can be configured as a closed loop, which cannot be manufactured by typical woven fibers. Patterns such as herringbone, nested loop shapes (e.g., continuous circles), highly branched and dendritic structures, articulated patterns, and waves can be formed. As well, superimposed indented dots in the grooves can produce fibers with raised points, making textiles with enhanced tactile properties. Furthermore, the line width resolution can be smaller than traditional textile fibers. Accordingly, fine fabrics beyond those that can be produced by using microfibers can be manufactured with the techniques described herein.

In other embodiments, the steps of the methods of forming a textile described herein can be utilized multiple times to form a series of textiles that can be assembled together. For example, the textile portions can be stacked or put together side-by-side. In some embodiments, the different layers can be formed from different precursors, giving each layer different properties. Such embodiments can result in the formation of unique textile structures with properties not found in typical textile materials. For instance, a textile structure can be formed using methods disclosed herein with two layers. A top layer forms a webbing with macroscopic opening that has a low thermal expansion coefficient. A bottom layer, attached to the top layer, forms a flat sheet with cut leaves that form a closure at positions adjacent to each of the macroscopic openings of the top layer. The bottom layer can be formed from one or more materials with a higher thermal expansion coefficient. When the temperature exceeds a critical level or range, the leaves of the bottom layer can separate from one another to form a macroscopic opening, while the expansion of the top layer is essentially unchanged. Accordingly, such a structure forms a smart textile for providing enhanced cooling at elevated temperatures, while providing enhanced insulation at lower temperatures. Development of similar smart textiles is enabled by the methods of the present application.

### Precursors and Multi-Phase Precursor Systems

Many material systems can act as precursors in embodiments of the present invention. For instance, precursors can include numerous polymer blends possessing either hydrophilic, hydrophobic, or both characteristics for application to a substrate. The polymer blends can include mixtures of any combination of amorphous or crystalline polymers, homopolymers or copolymers (e.g., random or block), dead polymers mixed with reactive components (e.g., monomers, oligomers, and crosslinkers, etc), and viscous reactive oligomers or macromers. Relevant reactions for network formation can be free-radical (e.g., using acrylates and/or styrenics) or condensation in nature. For example, an anionic polyacrylic acid/polyethylene terephthalate/anionic polyacrylic acid copolymer and a polysiloxane/polyalkyleneimine/polysiloxane copolymer can be complexed to form a fiber, the ionic segments coming together; in these instances, oligomeric segments can be substituted in any of the copolymers. In some instances, polycationics can act as at least a portion of a precursor (e.g., epoxies and/or vinyl ethers such as a PEG-PET-PEG block copolymer with terminal epoxy end groups). The polymers can be synthetic, natural (e.g., digested cotton or wool), or a hybrid of the two (e.g., a copolymer). Synthetic polymers span not only hydrocarbons, such as polyolefins, polyesters, acetates, acrylics, and nylons, but also fluorocarbons and silicones. In some embodiments, the substrate is configured to have an affinity for the precursor (e.g., a hydrophobic precursor being drawn into the organophilic coated gaps of a surface to form a fiber network such as a grid).

Polyester or nylon textiles can be produced by using partially polymerized precursors, or by using blends of dead polymers and yet unreacted or partially reacted precursors to obtain the desired consistency.

In some embodiments, the precursor used to form a textile shape is a multiphase mixture (e.g., a two-phase mixture of hydrophilic and hydrophobic components). Such multiphase mixtures can enhance textile shape formation when methods described herein utilize the inherent propensity of such mixtures to phase segregate (e.g., self assemble).

For instance, two-phase systems can spontaneously be attracted to different regions of a substrate depending upon the surface geometry (e.g., ridges and grooves) and/or the chemical nature of the surface. Accordingly, the substrate surface can include two or more different types of materials (e.g., hydrophilic and hydrophobic) to achieve such an embodiment. Such separation can be analogous to the phenomenon that bubbles tend to nucleate at fixed surface sites of a beverage container when a carbonated liquid is depressurized. In one illustrative embodiment, an organic-aqueous emulsion is utilized as a precursor, with a patterned substrate surface that includes silicone ridges and metal oxide grooves. In this embodiment, the organic phase has a tendency to self assemble around the surface ridges, while the aqueous phase tends to fill the grooves. Assuming that the organic phase contains a fiber precursor, which upon solidification or crystallization or polymerization becomes a fibrous material, and the aqueous phase upon evaporation becomes the void spaces, a fabric-like sheet can be constructed by using a set of patterned rollers to imprint the precursor while conducting the underlying casting process.

A variety of multiphase systems can be used as precursors in some embodiments of the present invention. In some embodiments, an aqueous phase can contain a fiber-forming material such as dissolved or digested cellulosics or proteinaceous polymers. In such cases, the organic phase can include volatile solvents for forming voids in the textile shape.

In another example, the organic phase of a multiphase precursor comprises a polyester dissolved in an acrylated formulation (e.g., polyethyleneterephthalate plasticized by a benzylacrylate and bisphenol-A-diacrylate mixture). The acrylated formulation, in one instance, can contain monomer/crosslinker/photo-initiator. The organic phase can be dispersed in an aqueous phase containing polyacrylic acid and carboxymethylcellulose. Upon spontaneous phase migration and self-assembly induced by patterned rollers, the resulting patterned sheet is flooded with a strong UV source to cure the precursor. Subsequently, the acrylate formulation polymerizes to form an interpenetrating molecular network within the polyester fibers. The water can evaporate, leaving a cellulosic material over-coating the organic fibers. When such an open-structured sheet fabric is formed, the system can be heated to crosslink the cellulosic material wrapping the patterned polyester fibers. Note that the fibers are anchored firmly by the acrylic formulation, providing fabric strength. Since the fiber orientation is organized according to the imprinted pattern, sheet flexibility is ensured. Finally, the cellulosic overcoat surrounding each fiber endows the fabric with a natural feel and desirable hydrophilic/wicking properties.

Other illustrative embodiments of the present invention use a partially polymerized fluorocarbon suspension in water. When placed in contact with a set of embossed rollers having patterned poly(tetrafluoroethylene) surfaces, the fluorocarbon material can congregate around the poly(tetrafluoroethylene) patterns, leaving the aqueous solution to fill metal oxide regions of the roller surface. A patterned sheet is thus generated, whereupon polymerization is allowed to complete by heat or UV. A lace-like fluorocarbon textile emerges at the end of this process.

Other precursors can be formed using an aqueous-organic-aqueous emulsion. In one instance, the elongated structures are formed by one or more organic-aqueous micellular structures. Upon evaporation of the aqueous phase, organic fibers can be created in-situ with a porous structure formed from the evaporated water phase. The pores can be randomly distributed in the fiber or can be a hollow orifice along the length of the fiber, i.e., having a core-shell structure. The fibers are, as before, flanked by mesh spacings left behind as the exterior water phase that previously surrounded the micelles evaporates. Such structures are not attainable by known conventional methods. It is understood that other processes can also be employed within the scope of the present invention to make porous or other structured fibers. For example, foaming or blowing agents can be added to a precursor formulation before the formulation is applied to a substrate. Subsequent processing of the precursor can remove such agents to leave a porous fiber.

In other embodiments, the fiber-forming phase of a multiphase precursor can be “seeded” by crystalline polymers or liquid crystal molecules. It may further contain micro-fibrils of a similar or dissimilar material, so the final fibers are composites. Polymers that previously were not amenable to fiber spinning can be processed directly into sheet fabrics. Note that the fiber-forming phase may also be pre-loaded with short and ultrafine staples.

### Application of Precursors by Ink-Jet Technology

Some embodiments of the present invention can utilize aspects of ink jet technology to deposit a precursor in a manner to form a pre-defined pattern for a textile (e.g., forming elongated structures by spraying liquid droplets). Aspects of ink application by ink-jet technology are understood by persons skilled in the art. In embodiments herein, precursors (e.g., liquid-like precursors) can be applied to a substrate (e.g., a flat or curved surface such as that of a roller) in a manner such as by application of small droplets through a nozzle in a desired pattern. In some embodiments, the substrate can be a flat surface. One or more nozzles that deposit precursor can be moved relative to the surface of the substrate to deposit the precursor in a defined pattern. Note that in such embodiments, the surface of the substrate need not have an embossed pattern to guide precursor patterning, though such substrate patterns can be utilized in conjunction. Alternatively, the substrate can be moved with one or more precursor deposition nozzles being held steady. The substrate can have a surface as described herein for the rollers or other substrate surfaces, such having a certain character surface physically (e.g., protrusions or dips) and chemically (e.g., hydrophobic or hydrophilic surface portions).

Since multiple nozzles can be employed, ink-jet deposition can potentially be performed more rapidly than traditional weaving or knitting. Numerous patterns can be created this way. Different nozzles can deposit different (reacting or non-reacting) precursors. The surface receiving the materials may be heated or irradiated to fuse or further polymerize the fabric patterns. Finally, textile can be removed (e.g., peeled off) the substrate surfaces.

Yet another variation is to use a plurality of nozzles, each discharging a continuous precursor stream to eventually be formed into fibrous material. The nozzles can be oscillated or moved in a prescribed manner relative to one another. This can be used to force the deposited strands to crossover one another. The substrate may or may not have pre-deposited patterns (such as parallel lines perpendicular to the direction of sheet travel). Heat fusion and/or photopolymerization may be optionally used to promote fabric integrity. Note that banks of nozzles may be placed at different locations along a conveyor belt or other nozzle-moving apparatus, some upstream while others downstream relative to one another. Continuous or discrete strands may be discharged onto the belt at pre-selected positions with or without oscillating or moving patterns. This manner of fabrication ensures that multiple layers are deposited on top of each other. Since different materials can be fed into different nozzles, different (and non-adjacent) layers may be fused together upon heating or irradiation. Thus, this fabrication technology offers the flexibility of creating criss-crossed junction points, where the strands in immediate contact are not glued together. Rather, alternating layers are connected (at pre-selected points) via fusing. The ability of using polymer precursors in this direct casting and imprinting (or the variant direct deposition and fusing) technology platform can allow very rapid manufacture of intricate patterns.

Textile Removal from Substrates

In many embodiments, upon curing of the precursor, the formed textile is removed from the substrate to yield the finished product. Accordingly, it can be advantageous to utilize precursor formulations that have a limited affinity for the substrate surface to facilitate textile removal after curing. In some instances, an agent can be applied onto the substrate surface, before the precursor is applied, to limit adhesion of the textile after formation.

In some embodiments, however, adhesion between a polymer/precursor system and the roller can be exploited to make fleece-like structures. If strong but transient adhesion exists between the precursor and the shape-producing device surface, “strings” or “whiskers” can extend from the fibers upon pulling the textile from the substrate until the viscoelasticity of the material ruptures the thin tethers between the device surface and the bulk material (e.g., textile fiber). Numerous tiny protrusions remain after detachment. Subsequent curing of the sheet fabric thus produced can cure in this fleece-like three-dimensional architecture. Note that a highly textured sheet can be produced by promoting string formation via a deliberately abraded mechanical surface full of microscopic defects. When a defect-free surface is used, and a mold release added to the precursor, standard patterns can be formed.

### Use of Preformed Fibers in Textile Formation

Some embodiments of the present invention are directed to hybrid textiles and fibrous materials in which preformed fibers are mixed with fibers that are created in-situ by a precursor. Preformed fibers include any type of fiber (e.g., natural or synthetic) that can be created beforehand using any technique. In these embodiments, parallel fibers or yarns are fed into a calender where the rollers have embossed lines perpendicular to the direction of fiber travel. A liquid substrate is patterned into perpendicular lines and deposited on the existing fibers, thus making a textile. Ample voids can be formed between the “warp” and “fill” yarns, i.e., fibers formed in-situ and pre-spun fibers. The new fibers can adhere to the pre-spun fibers to impart fabric strength when an appropriate liquid substrate is chosen. Yet, the focused overlap points allow the fibers to pivot, giving the fabrics sufficient flexibility. As before, the new fibers may be porous or solid, synthetic or largely natural, simple in construction or composite in structure. The new fibers may even possess a core-shell geometry through the use of organic-aqueous systems where both phases contain polymers or precursors. Potential fabric pattern may include wavy, curved, or articulated lines deposited on the pre-spun fibers. It is understood that various other techniques discussed herein can be utilized with preformed fibers to form textiles (e.g., use of ink jet techniques to form a fiber network with the preformed fibers).

Note that throughout the present application, textiles such as fabric sheets can be subsequently processed in a similar manner by operations generally known as dyeing and finishing, which includes techniques utilized in traditional textile industries. As an example of finishing, a cured or partially cured textile sheet may be embossed during or after casting deposition. In another example, a textile includes the use of pre-spun yarns of cotton with the precursor formed fibers being polyester in character. Coloring the novel textile using a cotton dye can impart the fabric with an unusual but desirable visual appearance. Traditional “stonewashing” can be obviated by the judicious selection of patterns.

### Carrier Layers as Substrates

Other embodiments of the present invention are directed to the use of one or more carrier layers as a substrate for textile formation. The carrier layer can act as a sacrificial structure to help form the substrate, akin to techniques using multi-layered lithography and dry-film resists in semiconductor manufacturing. In one example, a soluble sacrificial film can be employed. On either or both sides of the sacrificial film patterns of precursor are deposited, such as practiced in color printing. The precursor used on one side of the film can have a different chemical character than the precursor on the opposite side (e.g., hydrophilic film on one side and hydrophobic film on the opposite). Such patterns can optionally be multi-layered. The sacrificial film can contain one or more connections or openings, i.e., vias, between the opposite sides. These connections are pre-defined openings in the sacrificial film. Once the composite, multi-layered precursor is deposited, the sacrificial film can be dissolved away.

In other embodiments, the carrier layer can be removed (e.g., peeled off) and reused as the substrate for building additional textile structures. Note that in these embodiments, precursor deposition by printing is but one method of pattern generation; other precursor application steps as discussed in the present application can also be used such as photolithography, rapid laser scanning, for “spot welding” to stitch together layers, and technologies adopted from xerox-graphy can all be used as alternatives. Forming textile structures on both sides of a sacrificial film with embedded vias can give rise to fabric sheets where the fibers are intertwined, but not necessarily fused at overlapped points. This can increase the drape and/or stretch characteristics of the resulting product.

Other embodiments of the present invention use a carrier layer with pores, not only to form the precursor shape, but as a portion of the final textile. For example, a highly porous polytetrafluoroethylene film, which may be produced by extensive stretching, can be patterned as a cotton-like material. Precursor can be deposited on both sides of the film. The film pores can act as interconnects between the top and bottom precursor patterned layers. The precursor can be formulated as a cellulosic base material infused with binders, which can, upon heating, polymerize in the vias (and the deposited lines) to create a three-dimensional superstructure bridging through and covering portions or the entirety of the porous film substrate. Thus, a composite is formed whereby dissimilar materials co-exist intimately. This construction is vastly different from simple lamination of dissimilar materials such as used in layered Gore-Tex® materials, offering many mechanical property advantages.

In the above example, different materials can be deposited on different sides of the substrate, as long as they may be joined in the vias. Note that not all vias need to be plugged. In fact, many may remain open to maintain the breathability of the fabric. Furthermore, the substrate film for applying the precursor thereto can be ultra thin (e.g., approaching one to a few micrometers in thickness).

The substrate can also, or alternatively, have one or more embedded additives therein. Examples of additives include anti-microbial agents, fragrances, pest repellents, and a host of other chemicals. The substrate can be dyed or pigmented differently from the top/bottom imprinted fiber patterns, and/or can have a thin layer of metal deposition, giving a finished sandwich fabric that is conductive. It is also understood that any combination of such additives, and/or metal deposition can also be applied to a finished textile, consistent with other embodiments described herein (e.g., as a portion of a semi-solid precursor as described herein).

### Semi-Solid Precursors

Some embodiments of the present invention utilize a semi-solid precursor to form textiles. “Semi-solid” refers to a material that exhibits sufficient strength to be processed as a film, in contrast to a runny liquid, at the conditions of the process (e.g., temperature). In some instances, the semi-solid precursor has an elastic modulus in the range of a rubbery material, which can be between about 10⁶ dynes/cm² and about 10⁷ dynes/cm². If large pressures are utilized for shaping the precursor, the semi-solid precursor can include those that possess processable moduli of elasticity, i.e. under 10¹⁰ dynes/cm².

In some embodiments, semi-solid materials can be formed by mixing high molecular weight polymers with low molecular weight species. Examples include polymers and diluent mixtures, plasticized polymers and partially swollen polymers (e.g., swollen by solvents). The components can further be optionally reactive. For instance, “dead” polymers can have pendant functional groups that may be subsequently crosslinked. Diluents or plasticizers may be polymerized or crosslinked to form “interpenetrating polymer networks” (herein “IPNs”), or semi-IPNs. The semi-solid materials can also have reactive oligomers or macromers or mixtures thereof. The above formulations can optionally contain other additives, including dyes, pigments, antioxidants, anti-statics, fire retardants, bioactive agents, mold release agents, flow aids, and even microfibrils or pre-existing (natural or synthetic) discrete fibers.

When a semi-solid precursor is squeezed through a set of embossed rollers with intricate topography, holes, lines, and patterns can be formed therethrough, producing an open structure. Such openings can be formed before the precursor is completely cured to ease pattern formation. The openings can be further enlarged by moderate stretching of the film. Subsequently, the precursor can be heated, exposed to an energy source (e.g., UV, X-ray, microwave, electron beam or gamma radiation), or otherwise cured to completely react the reactive (but as yet unreacted) components to yield a fully solid sheet fabric.

Note that pattern generation does not have to rely on mechanical means such as cutting or punching the semi-solid film. In some embodiments, particles can be deposited on the surface of the semi-solid before being exposed to light or otherwise cured (i.e., the particles acting as a mask). Only the uncovered regions react, while the shadowed regions (i.e., masked regions) remain unreacted after this selective curing. Subsequent to this latent pattern generation operation, the unreacted portion can be dissolved away to create voids. Other types of masks can also be used, as in standard lithography, to replace opaque particles in pattern generation. Since the resolution desired for most textile formation is at least one order of magnitude coarser than that practiced in conventional semiconductor fabrication, the process can easily be implemented by those skilled in the art. For example, a Mylar film coated with patterned metal can be stretched across two remote rollers, giving a “tank-tread” between the radiation source and the precursor film traveling on a conveyor belt. Exposure through the “tank tread” masks imparts the desired pattern. Rapid laser scanning can be yet another option for creating a variety of fabric patterns in the film.

All the above processes can be repeated to achieve multi-layered structures. In some instances, various layered structures can be formed and partially cured before being combined into a multi-layered structure and finally cured. Alternatively, the precursor can itself be multi-layered, and exposure carried out on both sides of the film simultaneously. In multi-layering, one of the layers can be semi-solid-like with a more liquid-like precursor being applied thereto. Subsequent depositions can be viscous liquids. In the case of a multi-layered precursor, a central semi-solid film may be coated with liquid precursors on either or both sides to make laminated open structures in one step.

Semi-solid precursors can also be exemplified by porous films formed from partially polymerized conventional polyesters, nylons, or other appropriate polymer-based systems. After the lacey architecture is created, polymerization is allowed to be completed, while mechanical stretching in both the length and width directions is imposed. Thus, the struts (fibers) of the fabric structure can experience significant orientation/alignment of the crystalline polymers, and the holes can be enlarged as well to ensure fabric breathability and flexibility.

### Contoured Fabrics

Some embodiments of the present invention are directed to the formation of contoured fabrics, which can be tailored textiles that are geometrically and dimensionally tailored to reduce the need for measuring and cutting when forming particular textile products. By “contoured fabrics” we refer to textile objects that are generally considered to be different from a flat sheet. Thus, contoured fabrics may be as simple as a sheet with edges that are thicker and/or contain designed geometrical patterns, to a tube that is seamless and/or exhibits built-in ridges, pleats, and/or creases, to complex three-dimensional entities having topology characteristic of a shirt, a pair of pants, a glove or a sock.

Such embodiments offer the distinct advantage of rapid and automated textile object fabrication while minimizing or eliminating the need for cutting and sewing. Thus, disclosed are several intermediate and advanced products and/or parts of products that may be assembled by unconventional means to make the finished products. Aspects of the invention are illustrated in progression from simple to more complex designs by select examples. The invention is, however, in no way limited by these specific examples. It is instead intended to include the entire embryonic field of direct manufacture of textile objects that are contoured and have non-planar topology.

In some embodiments, a plurality of discrete, textile sheets, whose formation is described within the present application, are combined to form the contoured fabric. For example, the textile sheets, or particular regions with fibers can form a raised region relative to a remaining planar area, for example. Each individual sheet can be cast with fabric patterns simultaneously imprinted in either a mold surface (e.g., using temperature differential-induced fiber pattern generation) or other pattern formation techniques (e.g., using photochemistry-induced solidification for pattern generation). Final textile product manufacturing can be accomplished by quantitative metering of the precursor material into the patterned molds, whereupon discrete sheets are produced directly via casting and imprinting. The mold cavity can be fashioned to have the requisite geometry and dimension.

In some embodiments, the discrete sheets to be formed into a contoured textile can be assembled into one or more finished objects by conventional sewing operations. Alternatively, portions or the entirety of the borders of sheets can possess intricate mating designs, so that when the sheets are folded/curled to bring different edges together, the sheets can be snapped together (e.g., similar to Velcro action).

In other embodiments, the embellished edges can be designed to have a large cumulative surface area (e.g., by forming intricate features lying along the edges) relative to the remaining portions of the formed textile for imbibing and retaining an adhesive. Thus, when two edges are brought together, a fast-acting adhesive may be used to join the edges, forming a permanent seam. Note that the direct casting technology described herein easily permits the borders to be different from the interior of the sheets, affording unique joints or seams that are not accessible through gluing traditional woven or knitted fabrics. For example, one or more roller surfaces, or other substrate surface, can have a series of impressions that conform to the edge pattern desired.

In other embodiments, a contoured fabric can be assembled from individual sheets that are only partially cured, but with the incipient fibrous pattern already embedded or created in-situ. Such partially cured sheets can nevertheless be handled readily as a solid but flexible material. When the desired edges are brought and held together, the entire assembly is heated or irradiated (with any of a number of possible radiation sources such as UV, visible light, electron beam, microwave or gamma radiation). Strong joints are formed by this second-stage cure of the discrete sheets (with optionally embellished borders). Entire apparel or other textile objects are created by fusing pieces of precision sheets. Additionally, or alternatively, a semi-solid precursor can be utilized to make one or more individual layers for the contoured textile. Such layers can be individually handled and put together with other layers (e.g., layers that are also made from a semi-solid or partially cured precursor) before curing is performed.

Some embodiments are directed to a method for producing complex textile structures (e.g., a seamless, three-dimensional structure such as a tube-like textile structures) using complementary portions of a mold. Such structures can be created without the need to cut and/or fold sheets and join seams, providing potentially enhanced time savings and a seamless, aesthetically pleasing product. In one exemplary embodiment, a fabric-forming precursor can be applied to the exterior surface of a rod-shaped, or tube-like interior mold (i.e., the male half of the mold) which acts as a convex shaping portion. Two concave cylindrical pieces (i.e., forming the female half of the mold) can be positioned together and over the male half of the mold, imprinting the fabric-forming material. This operation can permanently set the tube-like object without the need for a secondary operation to sew seams. Sleeves and pant legs are examples of such tube-like objects that can be fabricated directly from fabric precursors through casting and imprinting.

Other embodiments can utilize the male/female mold concept described above to make more complex shapes. For example, the manufacturing of a glove can be customized to be rapid and tailored. Latex gloves are routinely produced by dipping a hand-shaped mold into a latex-forming solution. Upon drying, a texture-less and relatively impermeable glove is pulled off the mold. Embodiments of the present invention can provide an improved glove. In one particular embodiment, the process begins with dipping, spraying, or otherwise applying a fabric-forming precursor onto a convex male-half of a mold (e.g., a hand shape object). The male-half of the mold can have a textured surface. This surface can be configured to mesh with a patterned concave mold (i.e., the female half). The fabric-forming material can be shaped into a thin film and set by the matching mold halves. Optionally, the produced textile object can be formed with voids (mesh openings). Such a glove is breathable, unlike standard latex gloves.

Variations on the above process can be implemented within the scope of the present invention. For example, the precursor can alternatively be applied to the female half first, before the male half is inserted, or the precursor can be applied partially to both halves. In the latter case, different precursors can be utilized on each half to form a complex textile composite. In other embodiments, the precursor can be introduced into the cavity formed from putting the male/female portions of the mold together.

In other embodiments, layers of precursor can be added on top of one another to form a multilayered textile with a complex shape. Returning to the example of glove forming, a cellulosic layer can first be applied to the convex mold. Next a second application (e.g., a dip or spray operation) can be implemented over the cellulosic layer. Such a process can produce a latex glove that possesses a cotton-like interior. Such a glove can be advantageous, by providing comfort and helping avoid contact dermatitis.

The same strategy of glove production can be adopted to make other complicated apparel such as socks. Since matching mold halves are used, the directly cast and imprinted socks can have different thickness profiles readily incorporated into different parts of the socks (e.g., using thicker layers where more wear can be anticipated). Multi-layered socks can be produced as well. For example, the interior layer may be made of a wicking material or one that has low friction properties. The exterior layer may be rubbery, thus shock-absorbing. The exterior layer can further be foamed to ensure perspiration transport and enhanced cushioning performance.

It is clear that the above described technology for glove and sock manufacture can be extended to make other apparel objects and other complicated textile shapes generally. When necessary, a combination of contoured parts prepared by embodiments of the present invention can be joined together by conventional sewing or the seam-gluing process disclosed in this application.

The contoured fabrics manufactured according to embodiments disclosed herein can differ from those produced via traditional routes of cutting and sewing in yet another significant aspect. Cut and sewn objects invariably lead to tight-fitting and loose-fitting spots. The tight spots are prone to abrasion, while the loose spots are easily wrinkled. The contoured fabrics directly produced by casting and imprinting a precursor tend to be more uniformly “relaxed” yet form-fitting.

Finally, individualized garments can be produced by this invention. Deformable molds may be used to transition from one size to another. Such molds may inflate or deflate in response to internal hydrostatic pressure variations. When full garments can be mass-produced in this fashion, the technology offers the possibility for disposable apparel.

### Textile Surface Alteration

Some embodiments of the present invention are directed to altering the surfaces of a textile to have desired properties. In some of these embodiments, methods are described for a high-throughput manufacturing process, which can produce a hybrid composite textile. Some of the textiles deposit a precursor on an existing textile substrate, though such deposition can also be applied to other textiles or materials such as those described in the present application. The precursors can be patterned on the substrate, and can bond with the substrate without the need for an adhesive to adhere the precursor and substrate together. Advantageously, such hybrid materials can produce a textile which can preserve some of the inherent properties of the underlying substrate (e.g., drape, breathability, and/or strength properties) while altering selected properties such as surface, tactile, moisture management/repellency, and/or abrasion resistance attributes. Other embodiments are directed toward finished articles having using any of the textiles described in the present disclosure.

Some exemplary embodiments for creating a hybrid or composite textile begin with a pre-formed textile substrate, which may be woven, knitted, spun-bonded, cast, or produced by other means such as by the methods described in the present application. A precursor can be applied in a pattern to a surface of the substrate in any fashion, including the techniques described herein. For example, the substrate can be passed between two rollers. At least one of the rollers can have an embossed pattern on its surface. The patterned roller can pick up a precursor formulation (e.g., a polymer formulation) from a reservoir before contacting the substrate. Upon contact with the substrate sheet, the formulation can be transferred to the substrate. The roller and precursor properties can be selected such that the affinity of the precursor to the roller is less than the attraction between the substrate fabric and the formulation, such that the transfer is efficient. In other instances, the less efficient transfer can be desired to provide a given tactile nature to the precursor surface (e.g., akin to the whisker-like fibers of a fleece-like material. The precursor can then be cured, which can result in solidification of the precursor and/or bonding between the cured precursor and the substrate. The curing technique depends upon the type of precursor utilized, and can include such mechanisms as heating, UV or other light exposure, air drying, and other techniques including those described herein and known to one skilled in the art.

Potential precursors than can be utilized include any of the precursor formulations previously discussed herein. In some embodiments, the precursor is selected at least in part for its compatibility with a selected textile substrate. The precursor can be any number of engineered combinations of one or more polymers, oligomers, monomers, crosslinkers, and macromers, in the presence or absence of one or more appropriate solvents. The precursor can be capable of faithfully maintaining the imprinted pattern on the surface of the substrate for a certain period of time needed for the deposited material to bond permanently with the substrate, so the intended three-dimensional structure emerges after solidification and bonding between the newly deposited layer and the substrate.

Precursors can also be selected to impart particular desirable surface attributes. Some non-limiting examples include heat or light curables (e.g., UV), selected multi polymer combinations capable of multi-valent charge-charge complexation, inert polymers dispersed in reactive monomer/crosslinker mixtures (so called “reactive diluents”) that can form interpenetrating networks and semi-interpenetrating networks, and macromers and mixtures thereof. Some of the potential criteria are that the deposited patterns stay intact until cure and fusion with the substrate, and/or that the resulting layer possessing the desired surface properties. All such material combinations are within the scope of the present disclosure. In addition, a precursor patterns can be configured on the substrate to preserve the intrinsic properties of the substrate. For example, a series of precursor dots (or similar segments) can be patterned on a skin-contacting surface with a frequency pattern capable of imparting a particular tactile sensation while maintaining particular drape and breathability of the substrate.

As mentioned earlier, a variety of precursor application techniques can be employed. In one embodiment, application of the precursor can involve spraying droplets of the precursor formulation on a side of the substrate. Such a process can utilize techniques motivated from ink-jet spraying technology. Yet another viable approach is to utilize screen printing techniques for precursor application. Still another process of precursor application can utilize electro-photography techniques, where formulated droplets are transferred from a semiconductor roller with a latent image onto the substrate, and subsequently fused with the substrate. Those skilled in the art can devise other techniques to apply appropriate precursors (e.g., via ink jet, electro-photography, off-set, gravure, thermography, stamping, engraving, and screening printing, etc.). All such techniques fall within the scope of the present disclosure.

Some particular embodiments are described below, and serve to illustrate particular features of textiles in the present application.

A first particular embodiment utilizes a nylon fabric as a substrate. The fabric can be passed through a pair of rollers. On one roller is an embedded pattern that is essentially a densely distributed collection of recessed dots having a depth of about 10 micrometers. A polysaccharide-dominated formulation comprising chitosan (e.g., or other suitable polyamines, such as polyethyleneimine, polyvinylamine, polyallylamine, or any combination of polyamines), polyethylene glycol-epoxy and a pectin (or carboxymethyl cellulose) impregnates the recesses of the roller. Upon contact with the nylon fabric, the formulation is transferred onto the substrate. A dot-pattern is created on the nylon sheet surface. After exiting the rollers, the composite fabric is cured by heat to cause the amine groups on chitosan to react with the free acid end of the nylon molecules. The epoxy also reacts with the residual amines on both the chitosan and the free base end of the nylon molecules; the carboxylic acid groups on pectin either interact with the polyamines by charge-charge complexation or covalent coupling. The resulting composite fabric has numerous raised bumps of hydrophilic cotton-like “plugs” of approximately 10 micrometers in height. This textured surface gives rise to a very desirable hand feel, achieved without changing the intrinsic stretch and drape character of the underlying nylon. When high performance sports wear is made of this hybrid material, the bumped surface can be next to the wear's skin, wicking away perspiration efficiently, without deteriorating the strength and durability of nylon.

In a second particular embodiment, the exterior face of nylon sheet is applied with a large collection of droplets of a polymer that is a graft copolymer of a polyelectrolyte backbone with loops or tails of silicones attached. A candidate for the backbone is linear polyethyleneimine. Intermingled with the silicone side chains can be polypropylene oxide or polyethylene oxide, which are both oleophobic (repelling oil). The silicone side chains can serve to repel water-borne stains. Upon heat induced fusion with the nylon substrate, the surface layer is capable of both water and oil repellency. The nylon fabric remains soft.

Using a combination of the first and second particular embodiments above, a composite fabric comprising a nylon or polyester substrate sandwiched between a top layer of patterned dots of repellent material (for stain resistance) and a bottom layer of cotton-like bumps for wearer comfort and moisture uptake can be created, consistent with a third particular embodiment.

In a fourth particular embodiment, a sheet of cotton twill can be converted into a composite fabric with added performance benefits. The twill can be squeezed between two featureless, flat rollers. One roller can be lined with a Teflon release liner to facilitate release of coated liquid on its surface. The natural contour of the twill can allow the cotton threads to contact the roller surface at discontinuous locations when a modest pressure is applied to the roller set to pinch the moving fabric sheet. The release roller can be coated with an RTV silicone liquid doped with cyanoacrylate to accelerate curing and bonding with cotton. The precursor transfers to the raised areas of the cotton after passing through the calender rolls. Ambient moisture can quickly cure the liquid formulation, producing a soft yet abrasion/wrinkle resistant half-sheath on the coated surface. The opposite side of the composite fabric is still 100% cotton, retaining its intrinsic comfort and moisture wicking properties.

In a fifth particular embodiment, similar to the previous particular embodiment, an undyed cotton denim fabric is squeezed between two rollers. One roller has a grid-like pattern on its surface. This roller is coated with a dye-filled epoxy formulation (containing both elastomeric and siliconized ingredients) where the dye is a blue reactive dye (e.g., containing triazine functional groups for facile reaction with cotton). The transfer process creates a patterned colored fabric, where the colored regions not only enable the desirable finished look but also impart abrasion resistance to the fabric. The siliconized ingredient in the formulation gives a soft touch to the treated surface.

### Microfiber-Based Surface Alterations

Some embodiments of the present invention are directed to techniques for creating surface altering compositions for textiles (e.g., wovens and/or non-wovens). In particular, the surface altering compositions can be directed to changing the tactile properties of a native textile surface (i.e., the inherent tactile surface properties of the untreated textile). Such compositions can impart a hydrophilic and/or cotton-like feel to a textile that lacks such properties to enhance the attractiveness of the textile surface to touch. Accordingly, embodiments can utilize these compositions in textiles that are formed in various types of garments (e.g., diapers or garments with a stretchable film).

While such surface-altering compositions can be applied to any type of textile, some embodiments are directed to textiles that are made from synthetic fibers (e.g., fibers that are hydrophobic and/or lack a soft/cotton-like feel such as polyolefin yarns and polyester fleece). In some embodiments, the textiles exhibit elastic properties (e.g., the textiles can be stretched in at least one dimension to an extent of at least about 110% and return substantially to their unstretched dimension). Non-limiting examples of such textiles include polyesters, copolymers of polyethylene glycol and polyurethane (e.g., Lycra®-based materials), styrene/isoprene block copolymers, and other stretchable polymeric fabrics such as elastomeric materials and/or materials with plasticizers present. Materials exhibiting such elastic properties often lack the comfortable tactile feel of natural fibers such as cotton. Accordingly, the use of compositions that impart a cotton-like feel can provide a potential advantage.

Many of the surface-altering compositions comprise the use of a plurality of microfibers selected to provide the tactile-changing properties to an applied native textile surface. As utilized in the present application, microfibers refer to fibers with an effective average diameter (e.g., actual diameter or square root of an average cross sectional area) of less than about 500 micrometers. For example, the effective average diameter can be in a range between about 10 micrometers and about 100 micrometers. While any type of microfibers can be utilized, such as those described throughout the present application, naturally-occurring microfibers, such as cellulosic microfibers, can be beneficial in imparting desirable tactile properties. Cellulosic microfibers include cellulose-based fibers such as used in paper manufacturing. Synthetic microfibers and mixtures of natural and synthetic microfibers can also be utilized. In some embodiments, the microfibers (e.g., cellulosic microfibers) each are made from bundles of fibrils that are individually much thinner than the composite microfiber. The fibrils can be disassembled into separate fibers. Such fibrils can be nanofibers, which can exhibit an effective average diameter between about 1 nm and about 1 micrometer. For example, the individual fibrils can have an effective average diameter in the range from about 50 nm to about 500 nm. Microfibers can also span a variety of lengths. In some embodiments, the average length of the microfibers can range from about 10 mm to about 100 micrometers.

Fiber-containing compositions, having the microfibers dispersed in some type of dispersing fluid, can be distributed onto the textile to coat an entirety of a surface portion or to form a pattern (e.g., a matrix of dots or other discrete segments). Upon drying, the applied fiber-containing composition can form tactile-changing regions that impart the desired change in tactile properties to the applied area. The types of solvents utilized can depend upon the nature of the microfiber utilized. Organic solvents, water, and combinations of the two (e.g., alcohol and water mixture) can be used. Other components can also be added to the fiber-containing composition such as dispersing aids and surfactants (e.g., IGEPAL, a non-ionic surfactant available from Sigma Aldrich) to aid microfiber dispersal and deposition.

In some embodiments, the tactile-changing composition has a minimum thickness to impart the desirable tactile properties to a textile surface. Such a minimum thickness can be greater than about 1 micrometer. As well, the thickness can be less than about 1 millimeter. Accordingly, in some instances, the tactile-changing composition can be comprised of one or more fibrils from a microfiber.

The fiber-containing composition can be formulated such that the tactile-changing composition consists essentially of the microfibers. Embodiments that utilize such compositions can be utilized in disposable garments such as disposable diaper. In other embodiments, the fiber-containing composition can include additional components that can enhance the durability of the microfiber/textile ensemble. For instance, crosslinking agents can be added to the fiber-containing composition, which can result in the crosslinking of microfibers. For example, hydroxide groups on a cellulose-based microfiber can act as points for crosslinking. Potential crosslinking agents include molecules bearing one or more groups such as epoxides, isocyanates, aldehydes (e.g., glyoxal and glutaraldehyde), and other agents capable of crosslinking the microfibers.

In some embodiments, polycations can be attached to at least some of the microfibers to functionalize the microfibers. Functionalization of a polycation can act to increase the durability of the tactile-changing composition. Though any number of polycations can be utilized, in some embodiments the polycations include amine-containing polymers or oligomers. The amine groups of an amine-containing polymer can act as reaction points for attachment of other entities having appropriate functional groups. Such entities can act to attach microfibers together and/or microfibers to the textile material. Other entities can also be attached to the amine groups to impart other desirable properties. Non-limiting examples of additional entities include a UV blocker, a dye, a thickener, a dispersing aid, a compatibility aid, a deposition agent, and a hindered amine light stabilizer. Examples of amine-containing polymers/oligomers include aliphatic amine-containing polymers/oligomers and chitosan. Specific examples of aliphatic amine-containing polymers/oligomers include polydiallyl amine, polyallyl amine, polyvinyl amine, polyalkylenimine (e.g., having 2 to 10 carbon atoms per repeat unit in the backbone and/or a mixture of such alkyleneimines), and the like. Amine-containing polymers can also include copolymers having repeat units of different types of amine-containing homopolymers, such as copolymer utilizing repeat units of the examples of aliphatic amine polymers. It is also understood that mixtures of different types of amine-containing polymers can be utilized.

The presence of a polycation can act to enhance the durability of the tactile-changing composition by acting through any number of mechanisms. Not to be limited to any particular theory, in some instances the polycations can be attached to the textile and/or other polycations to help increase the integrity of the tactile-changing composition. For example, crosslinking agents such as those described previously (e.g., epoxides, isocyanates, and aldehydes) can be used to crosslink at least some of the polycations together and/or to crosslink the polycations to a textile material. Attachments can be made through any mechanism. Accordingly, non-limiting examples include covalent bonding, non-covalent bonding, electrostatic (or ionic) forces, Van der Waals forces, hydrogen bonding, entanglement of molecular structures, other intermolecular forces, and combinations of the listed mechanisms.

For example, in some embodiments, a selected coupling agent can be bound to an amine-containing polymer or oligomer (or other polycation), where the agent acts as an intermediary for attachment to another chemical entity on a textile surface and/or to another polycation (e.g., amine-containing polymer) and/or some other molecular entity (e.g., a dye or UV blocker). In some instances, a multifunctional coupling agent can be employed. As used herein, the phrase “multifunctional coupling agent” refers to agents which include at least two distinct types of functional groups that can be used to bind to other entities (e.g., a textile surface and/or a dye component). Examples of multifunctional coupling agents include an agent with a silicon atom or silane group for direct linkage to the amine-containing polymer. Multifunctional coupling agents can be any of a small-molecule, an oligomer, or even a polymer.

Though much of the following description is with reference to functional groups on a multifunctional coupling agent, it is understood that such groups can be utilized on other coupling agents as well within the scope of the present application.

In some embodiments, the multifunctional coupling agent can include a silicon-containing group and at least one other different type of functional group. Examples of other functional groups include an amine group, an amino group, an epoxy group, a hydroxyl group, a thiol group, an acrylate group, a carboxyl group, and/or an isocyano group. In one embodiment, the silicon-containing group can be a silane group. Instances of such groups can include an isocyanosilane, for example, a trialkoxy isocyanosilane such as trimethoxy isocyanosilane, triethoxy isocyanosilane, and/or triisopropoxy isocyanosilane. In certain embodiments, the multifunctional coupling agent may include an aminosilane, for example, a trialkoxy aminosilane such as triethoxy aminopropylsilane and/or trimethoxy aminopropyl silane. In certain embodiments, the multifunctional coupling agent may include an epoxy siloxane. The coupling agent can include triethoxy methacryloxypropyl silane. Though in many instances a multifunctional coupling agent is embodied as a bifunctional coupling having one silane group and one other group, it is understood that a multifunctional coupling agent can have one or more silicon-containing groups, and/or one or more other functional groups. It should also be understood that certain embodiments of multifunctional coupling agents need not include a silicon atom or a silane group.

In exemplary embodiments, the coupling agents can include one or more silanes with mono or multiple functional reactive groups such as hydroxyls, alkoxy (e.g., methoxy or ethoxy), or a halogen along with at least one reactive group on at least one other end (such as an amine, thiol, epoxy, isocyanate, or hydroxyl) to couple to the polycation (e.g., amine-containing polymer) or oligomer.

Though in the above illustration covalent bonding can cause connection of a functional group of a coupling agent with a polycation or other component, it should be understood that the functional group of a multifunctional coupling agent can induce binding by other mechanisms as well. The functional group can covalently link the agent to the polycation (e.g., amine-containing polymer); alternatively, the linkage may be non-covalent, ionic (e.g., electrostatic forces), or via Van der Waals forces, hydrogen bonds, and/or other intermolecular forces.

Attachment of a polycation to a microfiber can take place in any number of manners. For example, the polycation can be attached to a coupling agent first, followed by attachment of the polycation to a microfiber surface. Subsequently, the fiber-containing composition is developed with microfibers having the coupling agent present, and distributed to a textile surface. Any of the attachments can be accomplished by mechanisms such as covalent bonding, electrostatic or ionic interactions, van der Waals forces, and other molecular forces. In other instances, microfibers can be distributed to the textile surface, with coupling agents attached to the microfibers either before or after microfiber deposition. Subsequently, polycations are contacted with the distributed fibers to cause attachment thereto.

In some instances, attachment of the polycation to the microfibers can take place without the use of a coupling agent if the polycation has a portion capable of attachment to the particle surface by any of covalent bonding, electrostatic or ionic interactions, van der Waals forces, and other molecular forces. For instance, in some embodiments, polycations can also self-assemble on the surface of the microfibers without the need of an intermediary agent. For example, amine groups of an amine-containing polymer or oligomer can have a natural affinity for a negatively charged surface (e.g., a negatively charged microfiber surface such as a cellulose microfiber), resulting in an electrostatic or attractive ionic interaction. They can also be precipitated onto the surface, as is seen with chitosan, for example. Since chitosan is typically soluble in acidic aqueous conditions, it can be precipitated onto the surface of microfibers by suspending the fibers in an acidic aqueous chitosan solution and then raising the solution pH. Other polymers can be added onto the surface of the microfiber without using a crosslinking agent as well. These polymers can be precipitated onto the surface of the particles, spray-dried with the particles, or attached to the particles using any of the techniques familiar to artisans of ordinary skill in the field. Polycation attachment by electrostatic attraction can be performed either before the microfibers are applied to the textile surface or after the microfibers are applied to the textile surface.

In other embodiments, the microfibers can be dispersed in a fiber-containing composition that includes reactive monomeric groups. Such monomers can polymerize to form a polycation, which can adhere to the microfibers.

In some embodiments, a textile surface itself can be modified to enhance attachment of microfibers. For example, the textile can be formed of fibers or yarns that have functionalized groups, where at least some of the microfibers can attach to the textile surface by an interaction with the functionalized groups. The functionalized groups can interact with the fiber by any molecular force (e.g., covalent bonding, non-covalent bonding, or a combination of the two). In some embodiments, a multifunctional coupling agent is utilized to connect the functional group of the textile yarn with the microfiber (e.g., via a polycation such as an amine-containing polymer or oligomer). Accordingly, the functional group on the textile surface can be any suitable for binding with a multifunctional coupling agent.

In some embodiments, the functional groups on the textile yarn/fiber are derived from the yarn/fiber forming process, e.g., by adding an appropriate agent to the melt used to form the fiber/yarn of the textile. Such functionalized yarns/fibers can then be assembled (e.g., woven) to form the functionalized textile.

In other embodiments, a precursor of a binder composition can be combined with the fiber-containing composition to help enhance the integrity of the final tactile-changing composition. In some embodiments, the binder formed with the tactile-changing composition can act to attach at least some of the microfibers together and/or at least some of the microfibers to the textile material. The precursor and final binder composition can be any suitable composition compatible with the remaining components of the fiber-containing composition and tactile-changing composition. In some embodiments, the precursors and/or binder can include molecules having one or more functional groups such as epoxides, acrylics, polyurethanes, and melamine resins.

### Textile Applications

It is understood that the previously described embodiments provide only a few illustrative examples of the types of textiles and fibrous materials that can be created within the scope of the present invention. Many other processes are also possible and would be within the knowledge one of skilled in the art after being aware of the disclosure of the present application. For example, each of the described processes in the present application can be mixed and matched, including mixing and ordering various portions of such processes, and employed in succession or simultaneously.

Though many of the embodiments are described with respect to textile manufacturing and alteration, it is understood that such embodiments can be used to form other types of fibrous materials (e.g., fibrous materials in which the fibers are ordered in a defined pattern). Accordingly, such embodiments are not necessarily limited to use in textiles for traditional apparel, home furnishings, automotive, geotextile, and construction applications. The organized and patterned open architecture of the fibrous sheets and materials, within the scope of embodiments described herein, can find a great many non-traditional applications. We will give a few examples here. These are not intended to be comprehensive. All such applications are, however, covered by the present invention.

The first is the use of directly cast and imprinted fabrics as filtration media. Since strong materials can be patterned systematically and deliberately, traditional membrane technologies relying on phase separation, film stretching, or random particle bombardment will be superseded due to their lack of pattern organization. Next, an open architecture made of strong yet fine struts can act as scaffolding for paper making. Here, the sheet can be dipped into a traditional paper making slurry, whereby the paper-forming material is deposited in the open pores and then dried to yield products that are visually indistinguishable from traditional papers. The rapid and low cost production of the scaffolding sheet and the exceptional paper quality can lead to a new generation of such composite papers.

Yet another example of the utility of the present application is the use of elastomeric materials. An open network having fiber-like dimensions translates into a stretchy fabric. The fabric can be treated to give cotton-like tactile properties and hydrophilic perspiration wicking power. Multi-layered elastic architecture is ideal for shock-absorbing applications.

Bio-inert or biocompatible materials can be made into open-pore fabric sheets. Such fabrics can be used as hosts for cell culturing or tissue growth. When wrapped around implants, natural cells can fuse with the artificial prosthetics over time. Breathable bandages and temporary skin for treating burn victims may be produced. In all these biological and medical applications the benefits of controlled and organized pore architecture together with the engineered material offer great advantages over traditional woven fabrics or porous films where the coarse texture and randomly sized pores are disadvantages.

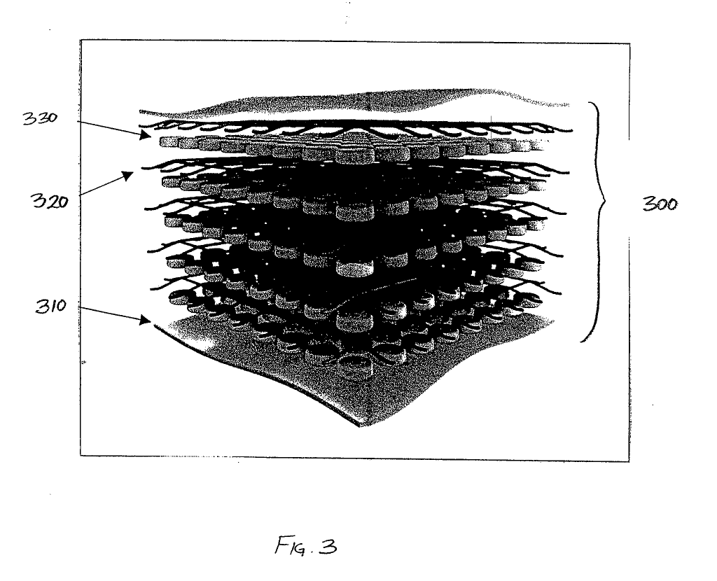

In another example, a superabsorbing material for use in applications such as diaper formation can be assembled using the techniques discussed herein. A starch film, made using the techniques discussed herein, which can be chemically modified to exhibit super absorbency, can be combined with a polymeric grid in patterned formation to give integrity to hold the starch film together. For instance, the polymeric grid can be formed of an amine-containing polymer (e.g., chitosan) or a curable polymeric system to form a reinforced structure using the application techniques described herein. Multiple layers can be utilized to form the material 300 as shown in FIG. 3. As depicted, one or more cover layers 310 can be used to impart a desirable tactile feel (e.g., cotton-like) quality to the outer layer of the material 300. Such a layer can comprise a cellulose-like material (e.g., fibers or polymer derived from a cellulose based material such as carboxymethylcellulose). Multiple layer of starch film 330 can be interspersed with structural grids 320 between the cover layers 310 to form the material 300.

In another example, a synthetic textile can be formed using the techniques discussed herein to form a material with pore sizes that change with temperature exposure. Such a textile can find applications in clothing or other fabric applications where temperature dependent breathability can be advantageously utilized (e.g., a coat which provides more insulation in low temperature environments and more breathability at higher temperature environments). The textile can be formed from multiple polymeric layers that have differing temperature properties such as differing glass transition temperatures (herein “T_{g}”) and/or thermal expansion coefficients. A layer made from a material with a higher T_{g}, and/or lower thermal expansion coefficient, can act as a structural template, and can exhibit a plurality of pores therethrough. Another layer, which can be formed from a material with a lower T_{g} and/or a higher thermal expansion coefficient, can act as a variable covering. At select temperatures (e.g., below a lower selected temperature), the variable covering can act to effectively block the pores of the structural template. At higher temperatures (e.g., above a higher selected temperature), the variable structure can expand in a manner to reveal at least a portion of the pores (e.g., large enough to at least allow the transport of water vapor through the textile). In some instances, there is an intermediate range (e.g., between the lower selected temperature and the higher selected temperature) where the variable structure transitions from completely covering the openings to at least partially exposing the openings, though this transition is not necessarily present (e.g., the higher selected temperature can be substantially the same as the lower selected temperature). While materials can be selected and configured to provide any specific selected temperatures, in some embodiments, the selected temperatures can be in the range from about 40° F. to about 120° F.

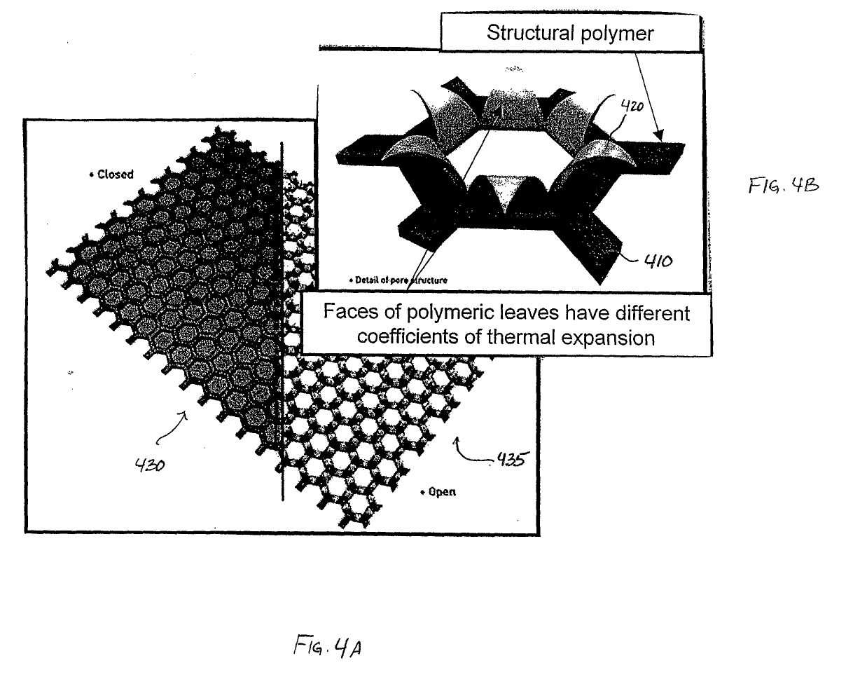

One embodiment of such a textile is exemplified in FIGS. 4A and 4B. As shown in FIG. 4A, the material in a closed configuration 430 has the pores blocked by the variable layer 430. At higher temperatures, the material is in an open configuration 435, which allows the pores access to the environment. These features are shown in more detail in FIG. 4B, showing how the pores of the structural layer 410 are exposed by bending leaflets of the variable structure 420. Of course, other configurations can also be utilized.

### EXAMPLES

The following examples are provided to illustrate some aspects of the present application. The examples, however, are not meant to limit the practice of any embodiment of the invention.

### Materials Used:

### Cellulose Microfiber

Engineered Fibers Technology EFTec Nanofibrillated Fiber Type L010-4

Shelton, Conn.

### Isopropanol

EMD Chemicals PX1834-1

Darmstadt, Germany

### IGEPAL

Sigma Aldrich 238694

St. Louis, Mo.

### Glyoxal

Sigma Aldrich 128465

St. Louis, Mo.

### Chitosan

Primex CG800

Siglufjodur, Iceland

### Example 1

### Cellulose Microfiber to Impart Softness

A 0.1% cellulose microfiber solution in 70% water/30% isopropanol and 0.1% IGEPAL was pipetted onto a swatch of a polyester fleece material (approximately 1 mL of solution per 4 cm²). Upon drying, the surface was softer to the touch compared to the more rubbery feeling polyester surface.

### Example 2

### Cellulose Microfiber with Glyoxal to Impart Softness

A 0.1% cellulose microfiber solution in 70% water/30% isopropanol and 0.1% IGEPAL was pipetted onto a swatch of a polyester fleece material (approximately 1 mL of solution per 4 cm²). After drying, an aqueous solution of 1.0% glyoxal was brushed on as a second application step. Upon drying, the surface was softer to the touch compared to the more rubbery feeling polyester surface. In addition, the sample showed rub-off resistance when dry and wet.

### Example 3

### Cellulose Microfiber Coated with Chitosan

A 0.5 mL of a 1% chitosan solution (chitosan solution made with acidic water) was slowly added to 100 mL of a 0.5% aqueous cellulose microfiber slurry.

### Example 4

### Chitosan Coated Cellulose Microfiber to Impart Softness

A 0.1% cellulose microfiber solution in 70% water/30% isopropanol and 0.1% IGEPAL was made from the cellulose microfiber slurry created in Example 3. This solution was pipetted onto a swatch of a polyester fleece material (approximately 1 mL of solution per 4 cm²). Upon drying, the surface was softer to the touch compared to the more rubbery feeling polyester surface.

### Example 5

### Chitosan Cellulose Microfiber with Glyoxal to Impart Softness

A 0.1% cellulose microfiber solution in 70% water/30% isopropanol and 0.1% IGEPAL was made from the cellulose microfiber slurry created in Example 3. This solution was pipetted onto a swatch of a polyester fleece material (approximately 1 mL of solution per 4 cm²). After drying, an aqueous solution of 1.0% glyoxal was brushed on as a second application step. Upon drying, the surface was softer to the touch compared to the more rubbery feeling polyester surface. In addition, the sample showed rub-off resistance when dry and wet.

### EQUIVALENTS

While the present invention has been described in terms of specific methods, structures, and compositions it is understood that variations and modifications will occur to those skilled in the art upon consideration of the present invention. For example, the methods and compositions discussed herein can be utilized beyond the preparation of the textile compositions in some embodiments. As well, the features illustrated or described in connection with one embodiment can be combined with the features of other embodiments. Such modifications and variations are intended to be included within the scope of the present invention. Those skilled in the art will appreciate, or be able to ascertain using no more than routine experimentation, further features and advantages of the invention based on the above-described embodiments. Accordingly, the invention is not to be limited by what has been particularly shown and described, except as indicated by the appended claims.

All publications and references are herein expressly incorporated by reference in their entirety. The terms “a” and “an” can be used interchangeably, and are equivalent to the phrase “one or more” as utilized in the present application. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1-46. (canceled)

47. A method of forming a textile having draping characteristics, comprising:
applying a precursor as a plurality of elongate structures onto a substrate to form a shape of the textile, the textile shape including void spaces;
curing the precursor to form fibers of the textile from the plurality of elongate structures; and
removing the textile from the substrate.

48. The method of claim 47, wherein at least one of the void spaces and the fibers of the textile have a characteristic dimension of at least about 1 micrometers.

49-51. (canceled)

52. The method of claim 47, further comprising:
depositing conductive metal on the textile.

53. (canceled)

54. The method of claim 47, wherein at least one fiber is a closed loop.

55. The method of claim 47, further comprising:
adhering the elongated structures to the substrate,
wherein the step of removing the textile comprises rupturing fibers to form whiskers extending from the fibers.

56. The method of claim 47, wherein the precursor comprises a semi-solid precursor.

57. The method of claim 56, further comprising:
forming openings in the textile shape before completely curing the precursor.

58-61. (canceled)

62. The method of claims 47, wherein the substrate is configured to arrange the precursor to form the textile shape.

63. The method of claim 47, wherein the substrate comprises at least one roller having parallel lines imprinted thereon, the at least one roller configured to arrange the precursor to form elongated structures.

64-66. (canceled)

67. The method of claim 47, wherein the precursor comprises a multiphase mixture.

68. The method of claim 67, wherein the multiphase mixture comprises an aqueous-organic-aqueous emulsion.

69-70. (canceled)

71. The method of claim 67, wherein the multiphase mixture comprises an organic-aqueous mixture having an aqueous phase comprising a fiber-forming material.

72-74. (canceled)

75. The method of claim 71, wherein an organic phase of the organic-aqueous mixture comprises a fiber-forming material.

76-77. (canceled)

78. The method of claim 62, wherein the substrate has a surface comprising at least one of ridges and grooves for forming the textile shape.

79. The method of claim 62, wherein the substrate has a surface comprising at least two different materials configured to form the textile shape.

80. The method of claim 62, wherein the substrate has a surface comprising at least one of a temperature gradient configured to form the textile shape, and a selected charge distribution configured to arrange the precursor to form the textile shape.

81. (canceled)

82. The method of claim 47, wherein the step of applying the precursor comprises forming at least one elongated structure on the substrate by depositing the precursor using an ink-jet technique.

83-85. (canceled)

86. The method of claim 47, wherein the step of applying the precursor includes applying the precursor using at least one of an air-knife technique, immersion, gap coating, curtain coating, rotary screen, reverse rolling, gravure coating, metering rod coating, a slot die technique, a hot melt technique, a flexo technique, silk screening, and anilox coating.

87-90. (canceled)

91. The method of claim 47, further comprising:
positioning a plurality of preformed fibers on the substrate, the elongated structures contacting the preformed fibers so as to form the shape of the textile.

92-93. (canceled)

94. The method of claim 47, wherein the step of applying the precursor onto the substrate comprises applying at least one precursor to opposite sides of a carrier layer, the at least one precursor filling at least one opening of the carrier layer, the method further comprising:
dissolving the carrier layer to form the textile.

95. (canceled)

96. The method of claim 47, wherein the substrate comprises a surface of a mold.

97. The method of claim 96, wherein the mold is configured to form a textile shape with edges capable of interlocking with edges of other textiles.

98. The method of claim 96, wherein the mold is configured to form a textile shape with edges having a roughness for promoting adhesive fixation.

99. The method of claim 96, wherein the step of curing the elongated structures comprises curing the elongated structures to a partially cured state, the method further comprising:
contacting the partially cured textile to at least one other partially cure textile; and
curing the contacted textiles to attach the textiles together.

100. The method of claim 96, wherein the mold comprises at least two complementary portions, the method further comprising:
applying the precursor to a surface of at least one of the complementary portions; and
contacting at least one other complementary portion to the applied precursor to form a three-dimensional textile shape.

101. The method of claim 100, wherein the textile shape comprises a tube-like structure.

102. The method of claim 100, wherein the textile shape comprises at least one of a sleeve, a glove, a sock, and a pant leg.

103. (canceled)

104. The method of claim 100, further comprising:
applying a second precursor to the at least one other complementary portion before the step of contacting.

105. The method of claim 96, wherein the mold is configured to form a textile fitted for a particular individual subject.

106. The method of claim 47, wherein the precursor comprises at least one of a polymer, an oligomer, a monomer, a crosslinker, a macromer, and a reactive diluent.

107. (canceled)

108. The method of claim 106, wherein the precursor is capable of forming a block copolymer.

109-132. (canceled)

133. A textile produced in accord with claim 47.
